(19) United States
(12) Patent Application Publication
(10) Pub. No.: US 2013/0173659 A1
(43) Pub. Date: Jul. 4, 2013

(54) Methods and Devices for Providing Location-Based Electronic Information

(71) Applicants: PEKING UNIVERSITY FOUNDER GROUP CO ., LTD., Beijing (CN); FOUNDER MOBILE MEDIA TECHNOLOGY (BEIJING) CO., LTD., Beijing (CN)

(72) Inventors: Changqiao WANG, Beijing (CN); Hongbo CHE, Beijing (CN); Yao DUAN, Beijing (CN)

(73) Assignees: FOUNDER MOBILE MEDIA TECHNOLOGY (BEIJING) CO., LTD., Beijing (CN); PEKING UNIVERSITY FOUNDER GROUP CO., LTD., Beijing (CN)

(21) Appl. No.: 13/731,902

(22) Filed: Dec. 31, 2012

(30) Foreign Application Priority Data
Dec. 30, 2011 (CN) 201110457549.X

(51) Int. Cl. G06F 17/30

(52) U.S. Cl. CPC G06F 17/30657
USPC 707/769

(57) ABSTRACT

The invention discloses a method and a device for providing location-based electronic information. In some embodiments, the method comprises the following steps: receiving an electronic information request carrying location information from a user terminal; querying pre-stored various electronic information for electronic information corresponding to the location information carried in the electronic information request; and providing the electronic information obtained from the query to the user terminal.

### RELATED APPLICATIONS

This application is based upon and claims the benefit of priority from Chinese Patent Application No. 201110457549.X, filed Dec. 30, 2011, the entire contents of which are incorporated herein by reference.

### FIELD OF THE INVENTION

The invention relates to the field of electronic information technology, and in particular to methods and devices for providing location-based electronic information.

### BACKGROUND OF THE INVENTION

With the rapid development of communication technology, more and more users have been using various intelligent terminal devices (hereinafter referred to as user terminals), such as smartphones, MIDs (Mobile Internet Devices), etc. for information interaction. These user terminals may be carried around and used for information interaction, and therefore, have increasingly become indispensible communication and recreational tools in everyday life.

Many merchants have developed various traditional discount and promotion activities such as, for example, distributing paper coupons, which may be used for purchase. Users may have to carry around the paper coupons, and the paper coupons may easily get lost. With the widespread use of the user terminals, electronic coupons have drawn more and more attention. Various merchants may upload their discount information onto a network, and the network can integrate the discount information of various merchants onto WebPages and provide the information to users. Users can browse the WebPages through web browsers to look for discount information they desire, download electronic coupons corresponding to the discount information to their own user terminals, and use the electronic coupons stored in their user terminals for purchase at corresponding merchants. Hereafter, we may refer to the above discount information viewed by the users as one piece of electronic information.

When a user is searching discount information corresponding to an electronic coupon as described above, the user may need to view each merchant's location associated with the discount information contained in the WebPages in order to find the discount information for certain merchants in a certain area. Because the WebPages may contain a large amount of information, this may greatly reduce the flexibility and the convenience of searching electronic discount information on WebPages.

Moreover, the above problem may also exist for other types of electronic information such as, for example, information relating to merchants stored on the network (e.g., address information, introduction information, telephone information, and the like). To search for information relating to merchants located in a certain area, users may need to view each merchant's address information in order to judge whether that merchant is located in certain area.

The present invention improves the flexibility and convenience in providing electronic information.

### SUMMARY OF THE INVENTION

Methods and devices for providing electronic information are described. In certain embodiments, a method and a device are disclosed for providing electronic information based on location.

Disclosed embodiments may include the following method for providing location-based electronic information. Consistent with certain embodiments, the method may include the steps of: receiving an electronic information request carrying location information from a user terminal; querying pre-stored various electronic information for the electronic information corresponding to the location information carried in the request; and providing the electronic information obtained by querying to the user terminal.

Consistent with certain disclosed embodiments, a device for providing location-based electronic information may include a receiving unit configured to receive an electronic information request carrying location information from a user terminal; an electronic information querying unit configured to query pre-stored various electronic information for the electronic information corresponding to the location information carried in the electronic information request; and an electronic information providing unit configured to provide the electronic information obtained by the electronic information querying unit to the user terminal.

In some embodiments, when a user wants to view electronic information in a specific area, the user may not need to view individual location information corresponding to the electronic information. Instead, the user may send an electronic information request carrying location information to the network directly through a user terminal the user may use. Upon receiving the electronic information request from the user terminal, the network may query pre-stored various electronic information for the electronic information corresponding to the location information carried in the electronic information request, and may send the electronic information obtained from the query to the user terminal.

### BRIEF DESCRIPTION OF THE DRAWINGS

FIG. 1 is an exemplary flowchart of a method for providing location-based electronic information consistent with the disclosed embodiments.

FIG. 2 is a diagram of an exemplary two-dimensional code consistent with the disclosed embodiments.

FIG. 3 is another diagram of an exemplary two-dimensional code consistent with the disclosed embodiments.

FIG. 4 is an exemplary flowchart for implementing a method for providing location-based electronic information consistent with some aspects of the disclosed embodiments.

FIG. 5 is a diagram of an exemplary device for providing location-based electronic information consistent with the disclosed embodiments.

### DESCRIPTION OF THE EMBODIMENTS

It is to be understood that the following detailed description is exemplary and explanatory only and is not restrictive of disclosed embodiments. For example, steps or processes disclosed herein are not limited to being performed in the order described, but may be performed in any order, and that some steps may be omitted, consistent with the disclosed embodiments.

Reference will now be made in detail to exemplary embodiments including, for example, their principle, specific implementing mechanisms, and the achievable effect. Examples of the exemplary embodiments are illustrated in the accompanying drawings and disclosed herein.

A user terminal, an information server, or a unit of the information server, may be any kind of device with memory and one or more processors, such as a smartphone, a PC, etc. Further, the functions of the user terminal, information server, and units of the information server may be implemented by computer programs stored in storage media. The one or more storage media may be a volatile or non-volatile, magnetic, semiconductor, tape, optical, removable, non-removable, or other type of storage device or tangible computer-readable medium.

FIG. 1 shows a flow chart of an exemplary method for providing location-based electronic information consistent with the disclosed embodiments. In some embodiments, the method may include the following.

Receiving an electronic information request carrying location information from a user terminal (Step 11).

In some embodiments, the electronic information may be discount information corresponding to electronic coupons (e.g., discount information of various merchants). In other embodiments, the electronic information may also be other electronic information such as, for example, electronic information relating to merchants or the like.

In some embodiments, the device providing the electronic information to a user may be but not limited to a server, such as an information server, or other devices at the network side. When a user wants to acquire electronic information, the user may send an electronic information request to the information server at the network side, the electronic information request may carry location information. Ways of sending the electronic information request to the information server by the user terminal may include, for example, the following two specific ways:

According to the first way of sending the request, the location information carried in the electronic information request may be the longitude and latitude coordinates of the current location of the user terminal. In some embodiments, when a user wants to acquire electronic information, the current location of the user terminal may be positioned, the longitude and latitude coordinates of the current location of the user terminal may be obtained by the user terminal, which may be used as the location information carried in the electronic information request sent by the user terminal.

In some embodiments, in the first way of sending the request, the user terminal may be configured to adopt Global Positioning System, location based services, Wi-Fi based positioning system, etc. to position its current location.

According to the second way of sending the request, the location information carried in the electronic information request is an area identifier selected by a user using the user terminal from various area identifiers provided by the user terminal, and the user terminal used by the user may provide a list of area identifiers. In some embodiments, when a user wants to acquire electronic information, the user may select, from the list of area identifiers, the area identifier of the area to which the electronic information the user desires to acquire belongs. For example, if the user wants to acquire discount information of various merchants in Haidian district of Beijing (China), the user may select, in the list of area identifiers provided by the user terminal, the area identifier “Haidian, Beijing,” and use the selected area identifier as the location information carried in the electronic information request sent by the user terminal.

In some embodiments, according to the second way of sending the request, the location information carried in the electronic information request from the user terminal may not be the longitude and latitude coordinates of the current location of the user terminal, but the area identifier of the area selected by the user.

In some embodiments, the user terminal used by the users may be smartphones, MID and the like.

Querying pre-stored various electronic information for electronic information corresponding to the location information carried in the electronic information request (Step 12).

In some embodiments, various electronic information may be stored in the information server. Upon receiving the electronic information request sent by the user terminal, the information server may extract the location information carried in the electronic information request, and may query the pre-stored various electronic information. In some embodiments, corresponding to the two ways of sending request disclosed in detail above, querying the pre-stored various electronic information may include, for example, the following two specific ways.

According to the first way of querying electronic information, with respect to the first way of sending the electronic information request, the information server may extract the longitude and latitude coordinates of the current location of the user terminal from the electronic information request, determine the area where the user terminal is currently located based on the extracted longitude and latitude coordinates, and query the pre-stored various electronic information for electronic information associated with the area where the user terminal is currently located. For example, if the electronic information the user wants to acquire is discount information corresponding to electronic coupons, the information server may determine that the area where the user terminal is currently located is “Haidian, Beijing,” based on the extracted longitude and latitude coordinates of the current location of the user terminal, and the information server may query the pre-stored discount information of various merchants for discount information of various merchants located in Haidian, Beijing.

According to the second way of querying electronic information, with respect to the second way of sending the electronic information request, the information server may extract the area identifier selected by the user from the electronic information request, and may query the pre-stored various electronic information for electronic information associated with the area corresponding to the area identifier selected by the user terminal For example, in the case that the electronic information the user wants to acquire is discount information corresponding to electronic coupons, and the area identifier that the information server extracts from the electronic information request sent by the user terminal is “Haidian, Beijing,” the information server may query the pre-stored various discount information of various merchants for discount information of various merchants located in Haidian, Beijing.

Providing the electronic information obtained from the query to the user terminal (Step 13).

In some embodiments, if the electronic information that the user wants to acquire is merchant information and the like, upon receiving the electronic information sent by the information server via the user terminal, the user may view the various merchant information, and thereby, the user may obtain address information, introduction information, telephone information and the like associated with each merchant.

Consistent with other embodiments, the electronic information that the user wants to acquire may also be discount information corresponding to electronic coupons, and in this case, the user may select the desired discount information from various discount information sent by the information server, and may send an information identifier corresponding to the selected discount information to the information server, and the information server may send electronic coupons corresponding to the discount information to the user terminal used by the user.

Consistent with some embodiments, electronic coupons may be configured to adopt the form of two-dimensional code information or other forms. The user may acquire the electronic coupons in ways including, for example, the following.

The user may select the desired discount information from the various discount information sent by the information server, and may incorporate the information identifier associated with the selected discount information in a two-dimensional code information request, and send the request to the information server. The information server may obtain the two-dimensional code corresponding to the discount information associated with the information identifier incorporated in the request, and send the two-dimensional code information to the user terminal.

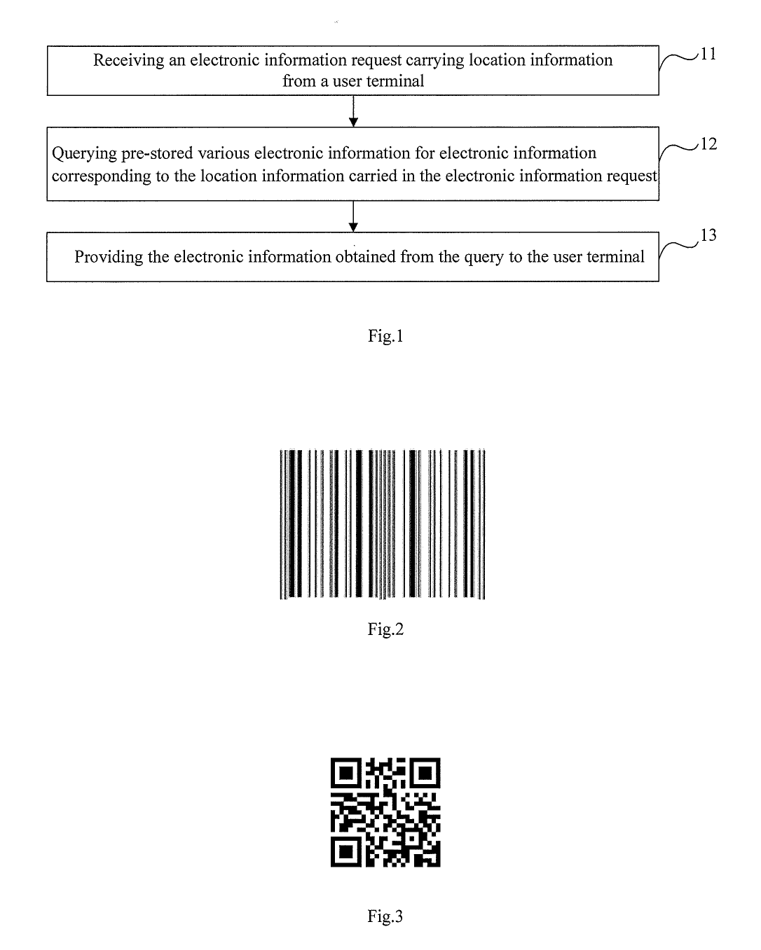

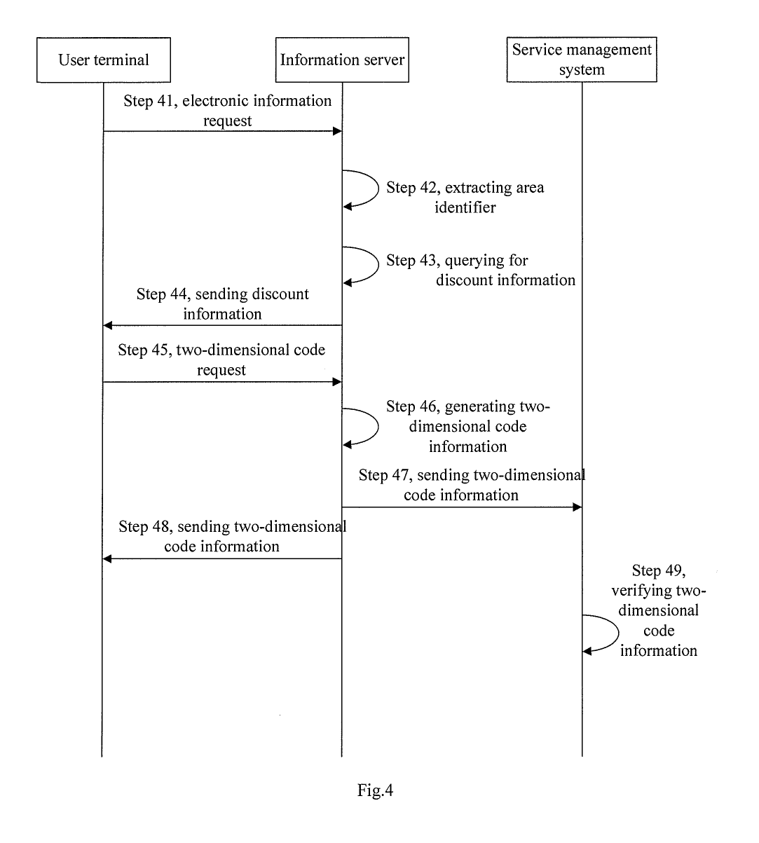

For example, a two-dimensional code may be a black and white graph distributed on a plane (in two-dimensional directions) with a degree of regularity, and may be used for uniquely identifying information. The two-dimensional code may be a row-based two-dimensional code or a matrix two-dimensional code. The row-based two-dimensional code may also be called a stacked two-dimensional code, formed by stacking multiple rows of short one-dimensional bar codes in appearance, as shown in FIG. 2. The matrix two-dimensional code may be in the form of a matrix, and at corresponding element positions of the matrix, “dot” may be used to represent binary “1,” and “null” may be used to represent binary “0.” The two-dimensional code may be formed by the arrangement of the “dots” and “nulls,” as shown in FIG. 3.

In some embodiments, the information server may generate the two-dimensional code information corresponding to the electronic coupons in advance. Additionally or alternatively, the information server may also generate the two-dimensional code information in real time. If the information server generates the code in advance, the information server may generate two-dimensional code information corresponding to discount information of various merchants in advance, store the generated two-dimensional code information corresponding to the discount information. Upon receiving the two-dimensional code information request, the information server may query the discount information corresponding to the information identifier carried in the two-dimensional code information request, query the two-dimensional code information corresponding to the discount information in the corresponding relation between discount information and two-dimensional code information, and send the two-dimensional code information obtained from the query to the user terminal. If the code is generated by the information server in real time, upon receiving the two-dimensional code information request, the information server may query the discount information corresponding to the information identifier carried in the two-dimensional code information request, generate two-dimensional code information for the discount information, and send the generated two-dimensional code information to the user terminal.

In some embodiments, after sending the two-dimensional code information to the user terminal, the information server may send the two-dimensional code information to a service management system of the corresponding merchant, and the service management system may store the two-dimensional code information corresponding to the discount information. In some embodiments, the discount information corresponding to the two-dimensional code information may include location information, purchase contents, defined times of use and period of validity and the like. In addition, the service management system may also record the time of use permitted for each two-dimensional code information to perform verification for time of use permitted for the two-dimensional code information. At purchase, the user may provide the two-dimensional code information to the merchant, and the merchant may scan the two-dimensional code information through a camera device and then send the scanned two-dimensional code information to the service management system for verifying the two-dimensional code information by the service management system. Specifically, the service management system may query discount information corresponding to the two-dimensional code information, obtain the times of use corresponding to the two-dimensional code information, and then verify the location information and the period of validity associated with the discount information, and check whether the times of use corresponding to the two-dimensional code information have achieved the times of use defined in the discount information. If the verification for the two-dimensional code information succeeds, the service management system may promptly indicate that the corresponding service may be provided to the user, add one time to the times of use corresponding to the two-dimensional code information, and then inform the information server of the times of use, so that the user may login the information server for query.

As discussed above, in some embodiments, when a user wants to view electronic information in a specific area, the user may not need to view locations corresponding to the electronic information one by one; instead, the user may send an electronic information request carrying location information to the network directly through a user terminal Upon receiving the electronic information request sent by the user terminal, the network may query the pre-stored various electronic information for electronic information corresponding to the location information carried in the electronic information request, and send the electronic information obtained from the query to the user terminal.

Another embodiment of the present invention will be given below.

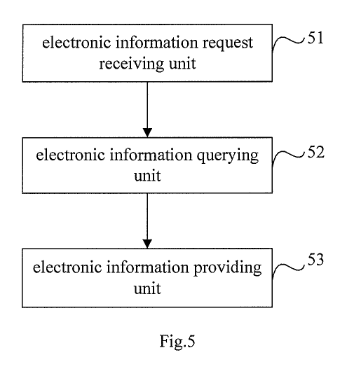

FIG. 4 shows an exemplary flowchart of a method for providing location-based electronic information consistent with the disclosed embodiments. The method may include, for example, the following steps.

At step 41, a user may select an area identifier from a list of area identifiers provided by a user terminal, the area identifier may be associated with the discount information of the merchants located in the area. The user may, via the user terminal, send a electronic information request carrying the selected area identifier to the information server.

At step 42, upon receiving the electronic information request, the information server may extract the selected area identifier carried in the electronic information request.

At step 43, the information server may query pre-stored discount information of various merchants for discount information of merchants in the area corresponding to the extracted area identifier.

At step 44, the information server may send the discount information obtained from the query to the user terminal.

At step 45, the user may search for the desired discount information in the various discount information provided by the information server, and may send a request for two-dimensional code information to the information server, the request may carry the information identifier corresponding to the selected discount information.

At step 46, the information server may generate two-dimensional code information for the selected discount information.

At step 47, the information server may send the generated two-dimensional code information to one or more merchants' service management system.

At step 48, the information server may also send the generated two-dimensional code information to the user terminal.

At step 49, at purchase, the user may provide the two-dimensional code information to the merchant, and the merchant may scan the two-dimensional code information through a camera device or the like, and may send the scanned two-dimensional code information to the service management system, and the service management system may verify the two-dimensional code information. If the verification succeeds, the service management system may give a prompt indication that corresponding service may be provided to the user.

Consistent with the disclosed embodiments, corresponding to the above method for providing location-based electronic information, FIG. 5 shows an exemplary configuration of a device for providing location-based electronic information. The device may include, for example, an electronic information request receiving unit 51 that may be configured to receive an electronic information request carrying location information from a user terminal, an electronic information querying unit 52 that may be configured to query pre-stored various electronic information for electronic information corresponding to the location information carried in the electronic information request, and an electronic information providing unit 53 that may be configured to provide the electronic information queried by the electronic information querying unit 52 to the user terminal.

The location information may be longitude and latitude coordinates of the location where the user terminal is currently located. The electronic information querying unit 52 may specifically comprise: an area determining sub-unit that may be configured to determine an area where the user terminal is currently located according to the longitude and latitude coordinates carried in the electronic information request; and an electronic information querying sub-unit that may be configured to query the pre-stored various electronic information for electronic information associated with the area where the user terminal is currently located.

The location information may be an area identifier selected by a user using the user terminal from various area identifiers provided by the user terminal. The electronic information querying unit 52 may be specifically configured to query the pre-stored various electronic information for electronic information associated with the area corresponding to the area identifier carried in the electronic information request

The device for providing location-based electronic information may further comprise, for example, the following.

A two-dimensional code information request receiving unit that may be configured to receive a two-dimensional code information request sent by the user terminal, where the two-dimensional code information request may carry an information identifier of the electronic information selected by the user from the provided various electronic information;

A two-dimensional code information obtaining unit that may be configured to obtain two-dimensional code information of the electronic information corresponding to the information identifier carried in the two-dimensional code information request; and

A two-dimensional code information providing unit that may be configured to provide the two-dimensional code information obtained by the two-dimensional code information obtaining unit to the user terminal.

In the embodiment of the invention, the above device for providing location-based electronic information may be but not limited to being placed in the information server on the network.

Various modifications and variations of the invention can be made by those skilled in the art without departing from the spirit and scope of the invention. Thus the invention is also intended to encompass these modifications and variations thereto so long as these modifications and variations come into the scope of the claims of the invention and their equivalents.

What is claimed:

1. A method for providing location-based electronic information, comprising:
receiving an electronic information request carrying location information from a user terminal;
querying, by at least one processor, pre-stored various electronic information for electronic information corresponding to the location information carried in the electronic information request; and
providing the electronic information obtained from the query to the user terminal

2. The method according to claim 1, wherein the location information is longitude and latitude coordinates of the current location of the user terminal.

3. The method according to claim 2, wherein querying electronic information corresponding to the location information carried in the electronic information request further comprises:
determining the area in which the user terminal is located based on the longitude and latitude coordinates carried in the electronic information request; and
querying electronic information associated with the area in which the user terminal is located.

4. The method according to claim 1, wherein the location information is an area identifier selected by the user using the user terminal from various area identifiers provided by the user terminal.

5. The method according to claim 4, wherein querying for electronic information corresponding to the location information carried in the electronic information request further comprises:
querying for electronic information associated with the area corresponding to the area identifier carried in the electronic information request.

6. The method according to claim 1, further comprising:
receiving a two-dimensional code information request from the user terminal, wherein the two-dimensional code information request carries an information identifier of the electronic information selected by the user from the provided various electronic information;
obtaining two-dimensional code information of the electronic information corresponding to the information identifier carried in the two-dimensional code information request; and
providing the obtained two-dimensional code information to the user terminal.

7. A device for providing location-based electronic information, comprising:
at least one processor;
a storage device storing instructions that, when executed by the at least one processor, cause the device to perform operations comprising:
receiving an electronic information request carrying location information from a user terminal;
querying pre-stored various electronic information for electronic information corresponding to the location information carried in the electronic information request; and
providing the electronic information obtained by querying for the electronic information to the user terminal

8. The device according to claim 7, wherein the location information is longitude and latitude coordinates of the current location of the user terminal.

9. The device according to claim 8, wherein the operations further comprises:
determining an area in which the user terminal is located based on the longitude and latitude coordinates carried in the electronic information request; and
querying the pre-stored various electronic information for electronic information associated with the area where the user terminal is located.

10. The device according to claim 7, wherein the operations further comprises:
receiving a two-dimensional code information request from the user terminal, wherein the two-dimensional code information request carries an information identifier of the electronic information selected by the user from the provided various electronic information;
obtaining two-dimensional code information of the electronic information corresponding to the information identifier carried in the two-dimensional code information request; and
providing the obtained two-dimensional code information to the user terminal.
